(19) United States
(12) Patent Application Publication
(10) Pub. No.: US 2025/0181893 A1
(43) Pub. Date: Jun. 5, 2025

(54) AUTOMATED ATTRIBUTE-BASED MACHINE LEARNING MODEL SELECTION

(71) Applicant: INTERNATIONAL BUSINESS MACHINES CORPORATION, Armonk, NY (US)

(72) Inventors: Nancy Anne Greco, Lagrangeville, NY (US); Shiqiang Wang, White Plains, NY (US); Nirmit V. Desai, Yorktown Heights, NY (US)

(21) Appl. No.: 18/526,560

(22) Filed: Dec. 1, 2023

(51) Int. Cl. G06N 3/045

(52) U.S. Cl. CPC G06N 3/045

(57) ABSTRACT

A method, computer system, and a computer program product are provided. A first data sample is received via a computer. The first data sample is compared to a collection of models to select one of the models that is determined as a best match for the first data sample. The comparing includes (A) the computer comparing metrics of data summarization for the first data sample to metrics of data summarization of the models and (B) the computer comparing a neural network metric for the first data sample to respective neural network metrics for the models.

### BACKGROUND

The present invention relates generally to the fields of machine learning, machine learning classification, and sample recognition that occurs using automated artificial intelligence.

### SUMMARY

According to one exemplary embodiment, a computer-implemented method is provided. A first data sample is received via a computer. The first data sample is compared to a collection of models to select one of the models that is determined as a best match for the first data sample. The comparing includes (A) the computer comparing metrics of data summarization for the first data sample to metrics of data summarization of the models and (B) the computer comparing a neural network metric for the first data sample to respective neural network metrics for the models. A computer system and computer program product corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment in which automated attribute-based model selection is performed according to at least one embodiment; and

FIG. 2 illustrates an automated attribute-based model selection process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a computer system, a method, and a computer program product for performing automated attribute-based model selection for selecting a suitable machine learning model to implement. Machine learning models have been implemented in various environments to help automate certain tasks such as confirmation of a correct assembly step in an assembly line, defect recognition in an object, etc. Environments and/or a type of object-to-detect are rapidly changeable due to industry and practical requirements. Knowing which machine learning model from a collection or library of trained machine learning models to apply is not always obvious. The present embodiments apply machine learning and automated analysis principles to help a system automatically select which machine learning model from a collection of machine learning models to apply for further analysis of a new data sample in response to receiving the new data sample.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as automated attribute-based model selection program 116. In addition to automated attribute-based model selection program 116, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and automated attribute-based model selection program 116, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

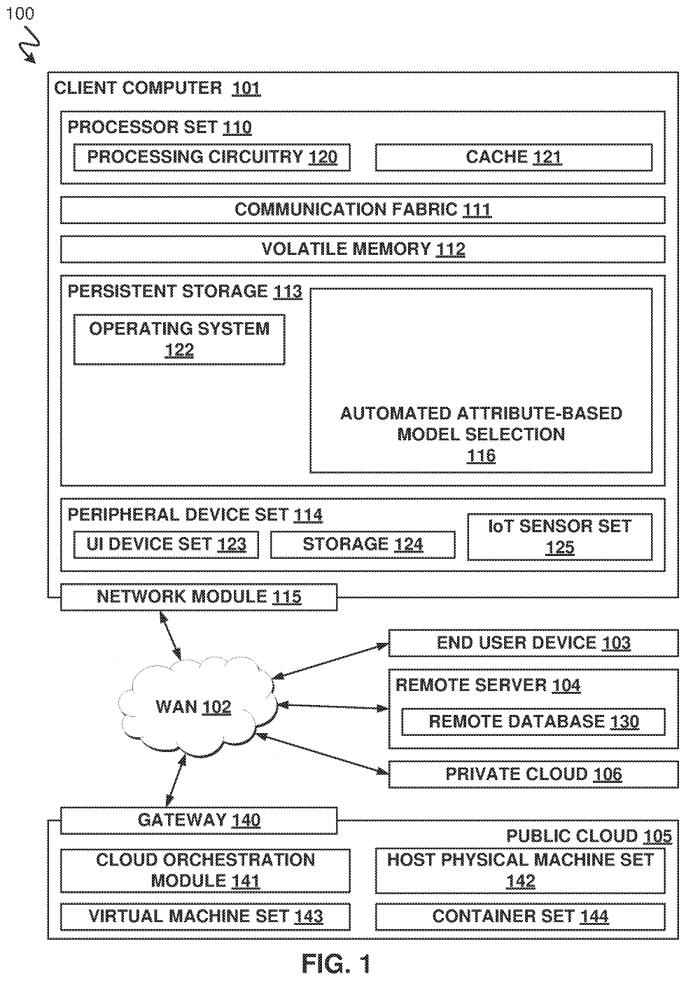

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores, Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in automated attribute-based model selection program 116 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in automated attribute-based model selection program 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing exceptionally large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computer 101 in some embodiments also hosts one or more machine learning models for classification, e.g., for image classification and/or object recognition, that are part of the collection of models. A machine learning model in one embodiment is stored in the persistent storage 113 of the computer 101. The received data sample is input to the machine learning model via an intra-computer transmission within the computer 101, e.g., via the communication fabric 111 to a different memory region hosting the machine learning model.

These machine learning models in some embodiments include one or more residual neural networks (ResNet) which are deep learning models, in which the weight layers learn residual functions with reference to the layer inputs, and which include skip connections that perform identity mappings that are merged with the respective layer outputs by addition.

These machine learning models in some embodiments include a real-time object detection algorithm that is a deep convolutional neural network that is able to detect objects in videos, live feeds, and/or images. In some embodiments the deep convolutional neural network uses one by one convolutions, sorts objects in images into groups with similar characteristics, processes input images as structured arrays of data, and/or recognizes images between the structured arrays. In some embodiments the deep convolutional neural network divides an image into a grid and evaluates a confidence of each grid matching with a predetermined class. In some embodiments, the deep convolutional neural network performs classification and bounding box regression simultaneously. In some embodiments, the deep convolutional neural network is trained using independent classifiers and binary cross-entropy loss for class predictions. In some embodiments, the deep convolutional neural network implements a multilabel approach with multiple predictions per grid cell. In some embodiments the deep convolutional neural network implements a softmax for individual grid cells to push the prediction to one class per grid cell.

In some embodiments, one or more machine learning models from the collection of models are stored in computer memory of a computer positioned remotely from the computer 101, e.g., in a remote server 104 or in an end user device 103. In this embodiment, the received data sample is input to the machine learning model via a transmission that starts from the computer 101, passes through the WAN 102, and ends at the destination computer that hosts the machine learning model. This machine learning model in some embodiments is a residual neural network or an object detection deep convolutional neural network or some other neural network. Thus, the models in some instances are located in different geographical locations and/or cloud entities. Thus, in some embodiments the program 116 at the computer 101 or another instance of the software at a central remote server performs routing of new requests to multiple server/geographical locations in a distributed system.

In such embodiments, a remote machine learning model is configured to send its output back to the computer 101 so that the determination of appropriate model of the collection of models is provided and presented to a user. The machine learning model receives a copy of the data sample, performs aspects of the attribute-based model selection, and transmits the results for a respective model back to the computer 101. In some embodiments, an analysis of model matching metrics and model selection are made via the program 116 at the computer 101. In other embodiments, the analysis of model matching metrics and model selection are made via a remotely stored instance/portion of the program 116 at the remote computer, e.g., remote server 104 and/or end device 103, and the information of which model is selected is transmitted via the wide area network 102 back to the computer 101.

In manufacturing today, a product line can change ever few hours and process a new product or variation on that product such that a different computer vision model is required. If the model is already created, a human generally is needed to select the model and initiate it, or put the name of the model in a workflow, and when that workflow is initiated, then the right model is used. The reliance on the human choosing the right model introduces error, especially as the number of models is expanding at a rapid rate, and the model names/tags may not be enough to distinguish the product and cause the error. In car manufacturing for example, some vehicles are customized with a slight variation in the placement of a logo, changes in the logo name, stripes added, color changes, slight wheel changes are fairly normal. To the human a list of models will be presented to them to choose from, but it could be hard to choose the right model for the customization for the product that is now running, so the human may accidentally choose the model for black stitching in a car seat and not the red. The wrong model selection can cause the line to stop.

Another problem that occurs when multiple factories are inspecting the same product, is one factory may produce a model and make the model available to the other factories, but it may not get into the workflow list of models to use, as the factory may have not seen this defect yet. A human again would need to assess the models and decide if the model belongs in the options to use for a particular workflow.

The present embodiments harness artificial intelligence and machine learning to help improve selection of a suitable machine learning model to apply for a particular situation, e.g., a particular manufacturing situation.

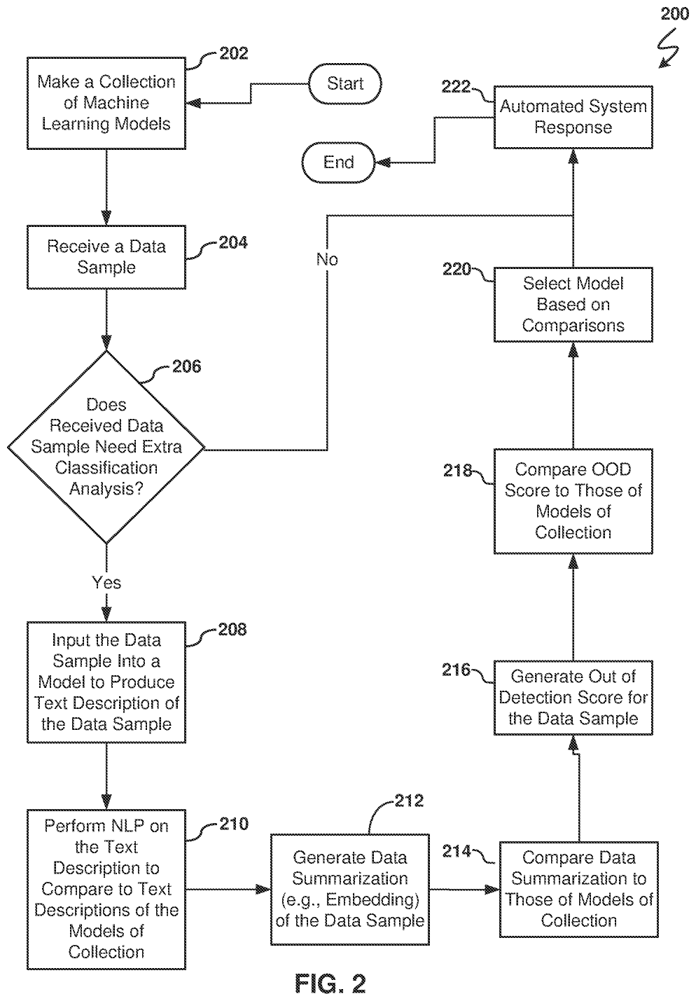

FIG. 2 illustrates an automated attribute-based model selection process 200 according to at least one embodiment. This automated attribute-based model selection process 200 is in at least some embodiments carried out via the automated attribute-based model selection program 116 described above and shown in the computing environment 100 of FIG. 1.

In step 202 of the automated attribute-based model selection process 200, a collection of machine learning models is made. This step 202 in some instances is considered a preparatory step that is performed before live-action implementation of the automated attribute-based model selection process 200. In some subsequent iterations of the automated attribute-based model selection process 200, the step 202 is skipped because the collection is already established. In some instances, step 202 includes training these machine learning models with training data. For example, in one implementation an assembly line is adjustable to assemble different portions of an object, e.g., is adjustable for assembling different portions of an automobile. A separate machine learning model is used to analyze aspects of the object and assembly of the various portions such as door, engine, frame, windows, drivetrain, etc. In some instances, these separate machine learning models are trained with training data that includes labeled samples. Such supervised training helps the machine learning model adjust weights and/or parameters in order to accurately predict the label in response to receiving the corresponding sample. Such a sample often includes one or more images. In other embodiments, the machine learning models perform object recognition for objects in a shipping or other commercial setting.

In some instances, a respective packet of information summarizing aspects of the particular machine learning model is saved as an aspect of step 202. This packet includes summarizing information such as a text description (e.g., a meta description, of the machine learning task and/or object to analyze by the particular machine learning model) of the machine learning model, a summary (e.g., a vector generated from the training data) of the training data used to train the machine learning model, and/or an acceptable range of an activation value generated by the machine learning model, e.g., during training with the training data. In some embodiments, the text description that is saved relates to information on data modality of the training data samples.

The summary of the training data, also referred to as the data summarization, of the packet of information in some instances refers to an embedding of one or more of the labeled training data. This embedding is generated by inputting the labeled training data/sample to an embedding layer of the particular machine learning model. The embedding layer generates an embedding/vector which maps the sample data from a high-dimensional space to a lower-dimensional space. This data summarization in some embodiments achieves dimensionality reduction and/or other compression of the original training data.

For the machine learning activation value of the packet of information, the acceptable range of a machine learning activation value in some instances is referred to as in-distribution score. For a sample which triggers a machine learning activation value outside of the acceptable range, the machine learning activation value is referred to in some instances as an out-of-distribution score. This machine learning activation value refers in some instances to one or more of an energy value of a logit layer of the machine learning model, an output value of another layer of the machine learning model such as an intermediate layer, an output value of an individual neuron of the machine learning model, and/or a combination of multiple single types of these values or of different types of these values. In some instances, the out-of-distribution score is generated by performing statistics on such a combination of values from the neural network.

In some instances, the packet of information includes a snippet of the machine learning model which allows the particular value to be generated. For example, the programming code representing a single layer and/or a single neuron is saved in the packet of information. This snippet is referred to as a logical entity in some instances. Thus, the programming code can be accessed separately to produce the value for a new sample, e.g., for comparison purposes.

The computer 101 in some embodiments hosts a collection of these summary packets of information. For example, a collection of these summary packets of information is stored in the persistent storage 113 of the computer 101. In other embodiments, each summary packet of information is stored in a computer that also hosts the respective machine learning model. Thus, in some embodiments with each summary packet of information stored near the respective machine learning model these summary packets of information are distributed in various machines such as various remote servers 104 along with the machine learning models. For such a distributed system, in at least some sub-embodiments a collection of these summary packets is also disposed in one embodiment centrally in a central remote server that is in communication with the computer 101 and its automated attribute-based model selection program 116 via data transmissions.

In some instances, the making of step 202 includes gathering access information to the various machine learning models, e.g., which are hosted in a distributed system. The access information is stored locally with the automated attribute-based model selection program 116. The access information in some embodiments includes internet addresses and/or security elements such as passwords that are needed for the program 116 in the computer 101 to remotely access and use the various machine learning models that are part of the collection.

In step 204 of the automated attribute-based model selection process 200, a data sample is received. In at least some embodiments, the data sample includes one or more images, e.g., of an object that is part of a system such as an element and that is being assembled together with other elements to produce a component, e.g., a phone, computer, automobile, etc. The data sample is received via a data transmission from an external computer to the computer 101 that hosts the program 116. In some embodiments, the data sample is captured via an input device that is directly connected to the computer 101. For example, a camera, a microphone, and/or a keyboard that is part of the UI device set 123 that is part of and/or connected to the computer 101 in a wired manner captures data and transmits that data to the program 116 within the persistent storage 113 of the computer 101. The data sample includes an image file, a video file, an audio file, a file with text, etc. and/or a combination of multiple of the aforementioned examples.

In step 206 of the automated attribute-based model selection process 200, a determination is made whether the data sample received needs extra classification analysis. If the determination of step 206 is negative in that the data sample does not need extra classification analysis, the automated attribute-based model selection process 200 skips many of its steps and proceeds to step 222. If the determination of step 206 is affirmative in that the data sample needs extra classification analysis, the automated attribute-based model selection process 200 proceeds to step 208. Step 206 is executed in various manners.

In some embodiments, the step 206 is performed in a situation where a process has been occurring but an incoming sample indicates a different machine learning model should be applied. For example, a process is occurring with incoming samples being examined by a first machine learning model. In response to the first machine learning model outputting an out-of-distribution indicator from a new incoming object/data sample, the program 116 is initiated to determine which machine learning model is more suitable to analyze the new incoming object/data sample. Thus, step 206 occurs with receiving an alert from a first machine learning model and/or receiving an output value from a first machine learning model and analyzing same. The analysis of the output value indicates whether the output value is outside of a suitable range and/or crosses (e.g., exceeds or falls under) a threshold value. The exiting of the range and/or crossing of the threshold triggers an affirmative determination of step 206.

In some embodiments, the step 206 is performed in a situation where a process has been occurring for a new environment for which little training data is available. Thus, a system is unclear initially which machine learning model to apply to a new incoming data sample. Thus, the bulk of the process 200 would be helpful to identify the most suitable machine learning model to apply to a new sample. The new incoming data sample indicates in some instances that additional similar data samples will be oncoming subsequently continuously for a time period and/or in a batch so that implementation of a particular machine learning model would be suitable. Such new environment could, for example, be present when new support elements, e.g., physical structure, for a process are presented and the various machine learning models are initially unfamiliar with interpreting the presence of the support elements in an image and/or video.

In step 208 of the automated attribute-based model selection process 200, the data sample is input into a model to produce a text description of the data sample. In some embodiments, the data sample is an image sample and step 208 is performed via inputting the image file(s) into an image-to-text machine learning model which analyzes the stored image and generates a brief text description of what the captured image shows. In some embodiments, the data sample of step 204 includes text and step 208 includes inputting the text into a summarization machine learning model which generates an abstract which summarizes the content and substance of the text. In some embodiments, the data sample includes an audio sample and step 208 includes inputting the audio file into an audio-to-text machine learning model which generates a textual description which summarizes the content and substance of the sounds recorded in the audio. In some instances, step 208 is performed without a machine learning model and instead by retrieving a stored title of the received data sample which already includes a textual description, e.g., a brief textual description, of the contents stored in the image. In some instances, the data sample is transmitted along with such textual title. In some embodiments, step 208 is performed via inputting the data sample into a classification machine learning model. The class name that is, in response, predicted by the classification machine learning model is taken as the text description of the data sample. In some instances, the text description that is produced in step 208 relates to information on data modality of the data sample.

In step 210 of the automated attribute-based model selection process 200, natural language processing (NLP) is performed on the text description to compare to text descriptions of the models of collection. This text description refers to the text description that was produced and/or retrieved in step 208. The text description from step 208 is compared to text descriptions retrieved and/or accessed from the collection of summary packets of information that summarize the machine learning models of the collection. In some embodiments, the program 116 includes a text comparator module to compare the text from step 208 with the candidate matching texts using brute force text matching and/or word root-based text matching. In some embodiments, the text comparator module identifies keyword patterns between the text description and the text descriptions from the collection of models. In some embodiments, the program 116 performs semantic NLP on a set of one or more of the words of the text description to find one or more matches from amongst the text descriptions from the summary packets of information summarizing the machine learning models. For example, the program 116 performs an embedding of the text description and embeddings of the text descriptions from the summary packets of information and compares these embeddings using vector comparison techniques such as cosine similarity.

In step 212 of the automated attribute-based model selection process 200, a data summarization of the data sample is generated. This data sample refers to the data sample that was received in step 204. In at least some embodiments, this data summarization is generated via inputting the data sample into an embedding layer and receiving an embedding vector as output from the embedding layer. Thus, this data summarization represents non-textual features/embeddings that are captured from an image that is input. The step 212 includes dimensionality reduction in some aspects to produce the data summary. The data sample has a higher dimension of variables and the produced summarization includes a lower dimension of variables. This data summarization in some embodiments achieves dimensionality reduction and/or other compression of the original training data. To maintain consistency, in at least some embodiments the data summarization technique(s) performed in step 212 are the same as those used in generating all or part of the packet of information from the training data from the collection of models to help provide more accurate comparison. By applying consistent techniques, the same embedding space is used for the comparison. In some embodiments, the same embedding layer that is part of one or more of the models in the collection of models is used to generate the data summarization. In other embodiments, an embedding layer that is not directly part of any of the models in the collection of models is used to generate the data summarization, albeit using similar techniques for accuracy in comparison in step 214. The data summarization is typically not machine learning model dependent.

In step 214 of the automated attribute-based model selection process 200, the data summarization is compared to those of the models of the collection. The data summarization refers to the data summarization generated in step 212 and is compared to respective data summarizations retrieved and/or accessed from the collection of summary packets of information that summarize the machine learning models of the collection. In some embodiments, this comparison of step 214 includes embedding comparison techniques such as a cosine similarity determination of the embedding vectors that are being compared. In at least some embodiments, the data summaries/summarizations of the models are generated by inputting training data to the models and extracting a respective vector that is representative of the training data and that was produced via the model.

In step 216 of the automated attribute-based model selection process 200, an out-of-detection score for the data sample is generated. The data sample refers to the data sample that was received in step 204. The out-of-detection score refers to a neural network metric such as a machine learning activation value. Examples of this machine learning activation value include but not are limited to an energy value of a logit layer of the machine learning model, an output value of another layer of the machine learning model, an output value of a neuron of the machine learning model, and/or a combination of multiple single types of these values or of different types of these values. Thus, step 216 includes inputting the data sample into a machine learning model with a neural network and receiving some output from the neural network. The output received is not necessarily a final output from the machine learning model but instead in some instances is a value extracted from an internal aspect, e.g., an internal layer and/or node, of the machine learning model. Such an extraction is setup via applying appropriate extracting code that obtains the value. In some embodiments, step 216 occurs with the data sample being input through one or more of the machine learning models of the library to extract the desired activation value that is generated during passthrough of the data sample. The neural network metric score is typically dependent on the machine learning model into which the sample is input.

In step 218 of the automated attribute-based model selection process 200, the out-of-detection score is compared to those of the models of the collection. The out-of-detection score generated in step 216 is compared to respective neural network scores retrieved and/or accessed from the collection of summary packets of information that summarize the machine learning models of the collection. The out-of-detection score is determined in at least some embodiments from the inputting of training data to the models (in order to train the models). In some embodiments, this comparison of step 218 includes the program 116 applying a comparator to compare various numerical values. The comparator determines whether the sample out-of-detection score falls within any of the acceptable ranges for the neural network metrics associated with the various machine learning models. For example, an acceptable range is defined in some instances by the corresponding values produced via the samples from the training data. In some embodiments, step 218 includes performing normalization on the various values to account for any structural differences of the neural networks whose values are being compared. In some embodiments, the scores of the models of the collection are determined by inputting the first data sample into each of these neural networks and extracting the desired neural network metric from the respective model.

In step 220 of the automated attribute-based model selection process 200, a model is selected based on the comparisons. These comparisons refers to those of steps 214 and 218 and additionally in some embodiments of step 210. In at least some embodiments, this model is selected from the collection of models that was made in step 202. The model which is the closest match based on the comparisons of steps 214 and 218 and optionally step 210 is selected in step 220. In some embodiments, the selection of step 220 includes giving a first weight to the comparison of step 214 and giving a second weight to the comparison of step 218. In some instances these two weights are equal. In some instances one of the weights is greater than the other of the weights based on a preference factor that is able to be input into the program 116 via a user accessing a graphical user interface associated with the program 116. In some instances, the text comparison of step 210 is also given a weight.

The comparison fit determined in step 220 is in some embodiments ranked from a best fit to a worst fit, with the best fit being selected in step 220. In some embodiments, the model selected via the program 116 includes a presentation of the name of the selected machine learning model. For example, a name of the selected machine learning model is visibly displayed on a display screen of the computer 101 and/or is audibly played on a speaker connected to the computer 101.

In step 222 of the automated attribute-based model selection process 200, an automated system response is performed. The automated system response in many embodiments includes implementing the machine learning model that was selected in step 220. For example, at an assembly line the received data sample from step 204 is then input into the selected machine learning model to cause the selected machine learning model to produce an output such as approval of a step performed or identification of a defect indicated in the data sample image. For embodiments in which step 206 proceeded directly to step 222 as mentioned above, the previous implementations of a machine learning model are maintained. Thus, the previously-active machine learning model is used to analyze the data sample received in step 204. This implementation in some embodiments includes uploading a copy of the selected machine learning model into the computer 101 for closer access and usage to analyze the data sample. In other embodiments, live access to a remotely held machine learning model is initiated. In other embodiments, access to the selected machine learning model is maintained with the computer 101 while access to the non-selected machine learning models is allowed to fall dormant until another iteration of the process 200.

After step 222, the process 200 is repeated in instances when a new data sample is received which appears to trigger out-of-distribution determination from the currently-active machine learning model. Alternatively, a user could manually actuate the process 200, e.g., steps 208 and onwards, by accessing an input element of a graphical user interface of the program 116 for example when a user is aware that a new element is being sent for analysis, e.g., a new element is being sent down an assembly line, and/or when a new environment is being used for production. Various steps of the process are in some embodiments performed on an automated basis in that completion of a prior step triggers, via the software, automated performance of the subsequent step of the process.

It may be appreciated that FIGS. 1-2 provide only illustrations of certain embodiments and does not imply any limitations with regard to how different embodiments may be implemented. Many modifications to the depicted embodiment(s), e.g., to particular steps, elements, and/or order of depicted methods or components of a neural network, may be made based on design and implementation requirements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A computer-implemented method for model selection comprising:
receiving, via a computer, a first data sample;
comparing the first data sample to a collection of models to select one of the models that is determined as a best match for the first data sample, wherein the comparing comprises:
comparing, via the computer, metrics of data summarization for the first data sample to metrics of data summarization of the models; and
comparing, via the computer, a neural network metric for the first data sample to respective neural network metrics for the models.

2. The computer-implemented method of claim 1, wherein the comparing of the metrics of the data summarization comprises:
inputting the first data sample into an embedding model and, in response, receiving an embedding vector from the embedding model, and
comparing the embedding vector to respective embedding vectors for each of the collection of models.

3. The computer-implemented method of claim 1, wherein the neural network metric for the first data sample is extracted from a first neural network in response to inputting the first data sample into the first neural network.

4. The computer-implemented method of claim 3, wherein the neural network metric is a logit layer energy score from the first neural network.

5. The computer-implemented method of claim 1, wherein at least one of the metrics of data summarization of the models and the respective neural network metrics for the models is obtained in response to inputting training data into the respective model.

6. The computer-implemented method of claim 1, wherein for the comparing of the first data sample to the collection of models the comparing of the metrics of the data summarization is given a first weight and the comparing of the neural network metric is given a second weight.

7. The computer-implemented method of claim 1, wherein the comparing of the first data sample to the collection of models is performed in response to a first computer analysis indicating an out-of-distribution determination for the first data sample.

8. The computer-implemented method of claim 1, wherein the comparing of the first data sample to the collection of models is performed in response to implementing the collection of models in a new environment and in response to receiving the first data sample.

9. The computer-implemented method of claim 1, wherein the comparing of the first data sample to the collection of models further comprises performing, via the computer, natural language processing to compare a text description of the first data sample to text descriptions associated with the models.

10. The computer-implemented method of claim 9, wherein the first data sample is a first image and the text description of the first data sample is produced via inputting the first image into an image-to-text model and, in response, receiving the text description as output from the image-to-text model.

11. The computer-implemented method of claim 9, wherein the first data sample is a first image and the text description of the first data sample is produced via inputting the first image into a classification machine learning model and, in response, receiving the text description as a class that the classification machine learning model predicts for the first image.

12. The computer-implemented method of claim 10, further comprising:
in response to selecting a first model of the collection of models via the comparing of the first data sample to the collection of models, uploading the first model for usage.

13. A computer system comprising:
one or more processors, one or more computer-readable memories, and program instructions stored on at least one of the one or more computer-readable memories for execution by at least one of the one or more processors to cause the computer system to:
receive a first data sample;
compare the first data sample to a collection of models to select one of the models that is determined as a best match for the first data sample, wherein the comparing comprises:
comparing metrics of data summarization for the first data sample to metrics of data summarization of the models; and
comparing a neural network metric for the first data sample to respective neural network metrics for the models.

14. The computer system of claim 13, wherein the comparing of the metrics of the data summarization comprises:
inputting the first data sample into an embedding model and, in response, receiving an embedding vector from the embedding model, and
comparing the embedding vector to respective embedding vectors for each of the collection of models.

15. The computer system of claim 13, wherein the neural network metric for the first data sample is extracted from a first neural network in response to inputting the first data sample into the first neural network.

16. The computer system of claim 15, wherein the neural network metric is a logit layer energy score from the first neural network.

17. The computer system of claim 13, wherein at least one of the metrics of data summarization of the models and the respective neural network metrics for the models is obtained in response to inputting training data into the respective model.

18. The computer system of claim 13, wherein for the comparing of the first data sample to the collection of models the comparing of the metrics of the data summarization is given a first weight and the comparing of the neural network metric is given a second weight.

19. A computer program product comprising a computer-readable storage medium having program instructions embodied therewith, the program instructions executable by a computer to cause the computer to:
receive a first data sample;
compare the first data sample to a collection of models to select one of the models that is determined as a best match for the first data sample, wherein the comparing comprises:
comparing metrics of data summarization for the first data sample to metrics of data summarization of the models; and
comparing a neural network metric for the first data sample to respective neural network metrics for the models.

20. The computer program product of claim 19, wherein the comparing of the metrics of the data summarization comprises:
inputting the first data sample into an embedding model and, in response, receiving an embedding vector from the embedding model, and
comparing the embedding vector to respective embedding vectors for each of the collection of models.
